(19) United States
(12) Patent Application Publication
(10) Pub. No.: US 2024/0329353 A1
(43) Pub. Date: Oct. 3, 2024

(54) LENS UNIT

(71) Applicant: NIDEC INSTRUMENTS CORPORATION, Nagano (JP)

(72) Inventors: Tomoaki NAKAJIMA, Nagano (JP); Tadashi KOMIYAMA, Nagano (JP)

(73) Assignee: NIDEC INSTRUMENTS CORPORATION, Nagano (JP)

(21) Appl. No.: 18/623,042

(22) Filed: Apr. 1, 2024

(30) Foreign Application Priority Data
Apr. 3, 2023 (JP) 2023-059822

(51) Int. Cl. G02B 7/02

(52) U.S. Cl. CPC G02B 7/021

(57) ABSTRACT

A lens unit has a lens and a lens disposed from an image side toward an object side and a second lens barrel accommodating them, and the lens includes a fitting portion fitted to the lens on an image side. A fitted portion to which the fitting portion is fitted from the object side is provided on a surface on the object side of the lens. An inner peripheral-surface portion on an outer side in a radial direction of the lens on an inner peripheral surface of the second lens barrel includes fitting protrusions pressure-joined to the lens at plural spots separated in a circumferential direction. An inner peripheral-surface portion on the outer side in the radial direction of the lens includes guide protrusions for guiding the lens in an optical axis direction at plural spots separated in the circumferential direction.

### CROSS REFERENCE TO RELATED APPLICATION

This application claims the priority benefits of Japanese Application No. 2023-059822 filed Apr. 3, 2023. The entirety of the above-mentioned patent application is hereby incorporated by reference herein and made a part of this specification.

### BACKGROUND

### Field of the Invention

At least an embodiment of the present invention relates to a lens unit that holds a plurality of lenses in a lens barrel.

### Description of the Related Documents

A lens unit in which a plurality of lenses are held in a lens barrel which is a resin-injection molded product is described in Japanese Unexamined Patent Publication No. 2006-201378. In this document, a cross section of an inner peripheral surface of the lens barrel cut in a direction orthogonal to an optical axis has a regular dodecagonal shape. An inner diameter of an inscribed circle of the regular dodecagonal shape is slightly smaller than an outer diameter of the lens to be inserted therein. The lens is accommodated in the lens barrel by press-fitting, and the inner peripheral surface of the lens barrel having a regular dodecagonal shape and the outer peripheral surface of the lens are in pressure contact. As a result, the lens is positioned in a radial direction.

In order to improve relative positional accuracy of two lenses adjacent to each other in an optical axis direction, it is conceivable to position the lenses with respect to each other. For example, it is considered that a fitting portion is provided in one lens, a fitted portion is provided in the other lens, and the two lenses are positioned in the optical axis direction and the radial direction by fitting the fitting portion and the fitted portion to each other. However, such a structure of a lens unit that is suitable for accommodating two lenses in a lens barrel and fitting the two lenses in the lens barrel so as to improve positional accuracy between the lenses has not been provided.

In view of the aforementioned problem, it is an object of at least an embodiment of the present invention to provide a lens unit in which two lenses are accommodated in a lens barrel, and the two lenses are fitted to each other so as to improve the positional accuracy between the lenses.

### SUMMARY

In order to solve the aforementioned problem, a lens unit of at least an embodiment of the present invention is characterized by including a first lens and a second lens disposed in this order from an image side to an object side, and a lens barrel which accommodates the first lens and the second lens on an inner peripheral side, in which the second lens includes a fitting portion which is fitted to the first lens on a surface on the image side, and when a direction along an optical axis of the first lens is defined as an optical axis direction, the first lens is supported from the image side at a predetermined first position in the optical axis direction, on a surface of the first lens on the object side, a fitted portion to which the fitting portion is fitted from the object side is provided, a first inner peripheral-surface portion located on an outer side in a radial direction of the first lens on an inner peripheral surface of the lens barrel includes first fitting protrusions which are pressure-joined to the first lens at a plurality of spots separated in a circumferential direction, a second inner peripheral-surface portion located on the outer side in the radial direction of the second lens on the inner peripheral surface of the lens barrel includes guide protrusions which guide the second lens in the optical axis direction at a plurality of spots separated in the circumferential direction, a plurality of the first fitting protrusions position the first lens in the radial direction, and the first lens is positioned in the radial direction with respect to the second lens by fitting of the fitting portion and the fitted portion.

In the lens unit according to at least an embodiment of the present invention, a fitting portion is provided on a surface on the image side of the second lens located on the object side in the two lenses. On the other hand, on the first lens located on the image side, a fitted portion to which the fitting portion is fitted from the object side is provided. Further, the first lens is supported at a predetermined first position in the optical axis direction. Furthermore, the first lens is positioned in the radial direction by a plurality of first fitting protrusions protruding from the first inner peripheral-surface portion of the inner peripheral surface of the lens barrel. Here, the second inner peripheral-surface portion located on the outer side in the radial direction of the second lens on the inner peripheral surface of the lens barrel includes guide protrusions which guide the second lens in the optical axis direction at a plurality of spots separated in the circumferential direction. Therefore, when the second lens is inserted into the lens barrel from the object side after the first lens is accommodated in the lens barrel and positioned in the optical axis direction and the radial direction, the second lens is guided in the optical axis direction by the guide protrusions, and the fitting portion of the second lens can be inserted into the fitted portion of the first lens. Further, since the second lens is guided in the optical axis direction by the guide protrusions, the fitting portion of the second lens can be fitted to the fitted portion of the first lens by pushing in the second lens toward the lens from the object side in the optical axis direction. Thus, according to the lens unit of at least an embodiment of the present invention, the positional accuracy between the lenses can be improved by fitting these two lenses while accommodating the two lenses in the lens barrel.

In at least an embodiment of the present invention, the fitting portion may include a fitting-portion tapered surface surrounding the optical axis and inclined to an inner peripheral side toward the image side, the fitted portion may include a fitted-portion tapered surface surrounding the optical axis and inclined to an outer peripheral side toward the object side, so that, when the fitting portion and the fitted portion are fitted to each other, the fitting-portion tapered surface and the fitted-portion tapered surface are brought into surface contact with each other. With this configuration, it is easy to fit the first lens and the second lens by pushing in the second lens toward the first lens from the object side. Further, the fitting-portion tapered surface and the fitted-portion tapered surface come into surface contact with each other, whereby the first lens and the second lens are positioned with respect to each other in the radial direction.

In at least an embodiment of the present invention, in a state where the fitting portion and the fitted portion are fitted to each other, a clearance may be provided between the second lens and the plurality of guide protrusions. With this configuration, it is possible to prevent the guide protrusions provided on the lens barrel from interfering with the second lens, whereby lowering of the positional accuracy between the first lens and the second lens can be prevented.

In at least an embodiment of the present invention, it may be so configured that the lens barrel is made of a resin, the first inner peripheral-surface portion is a tapered surface inclined to an outer peripheral side toward the object side, and the first fitting protrusion includes a pressure-joining surface parallel to the optical axis at an end on an inner peripheral side. With this configuration, the first lens is positioned in the radial direction by the first fitting protrusion protruding from the first inner peripheral-surface portion of the lens barrel made of a resin. Here, if the first inner peripheral-surface portion is formed as a tapered surface inclined to the outer peripheral side toward the object side, the first inner peripheral-surface portion includes a “draft angle” which makes it easy to separate the mold and the lens barrel in the optical axis direction of the first lens (the axial direction of the lens barrel) at the time of mold release for separating the mold and the lens barrel at the time of resin molding. As a result, since generation of stress in the lens barrel at the time of mold release can be suppressed, the generation of distortion in the lens barrel due to this stress can be prevented or suppressed. Therefore, it is possible to prevent or suppress lowering of the positional accuracy of the first lens held by the lens barrel. Further, the first lens and the first fitting protrusion are pressure-joined on surfaces. Therefore, the inclination of the first lens with respect to the optical axis can be prevented or suppressed.

In at least an embodiment of the present invention, it may be so configured that the second inner peripheral-surface portion is a tapered surface inclined to the outer peripheral side toward the object side, and the guide protrusion includes a guide surface parallel to the optical axis at an end on the inner peripheral side. When the second inner peripheral-surface portion is formed as a tapered surface inclined to the outer peripheral side toward the object side, the second inner peripheral-surface portion includes a “draft angle” which makes it easy to separate the mold and the lens barrel in the optical axis direction at the time of mold release for separating the mold and the lens barrel at the time of resin molding. As a result, since generation of stress in the lens barrel at the time of mold release can be suppressed, the generation of distortion in the lens barrel due to this stress can be prevented or suppressed. Further, when the guide protrusion includes a guide surface parallel to the optical axis at the end on the inner peripheral side, the second lens can be guided easily in the optical axis direction without being inclined to the optical axis.

In at least an embodiment of the present invention, it may be so configured that a third lens disposed on the object side of the second lens and an O-ring disposed between the second lens and the third lens are provided, the third lens and the O-ring are accommodated in the lens barrel, the lens barrel includes an annular caulking portion which is bent toward an inner peripheral side and is brought into contact with an outer peripheral-end portion of the third lens from the object side at an end part on the object side and a first stepped portion on an inner peripheral surface, the first stepped portion includes an annular seating surface facing the object side at a position overlapping the caulking portion when viewed from the optical axis direction and an annular wall surface extending from an end on an inner peripheral side of the seating surface to the image side, an outer peripheral-edge portion of the third lens is located between the caulking portion and the seating surface, the first lens is supported from the image side at a predetermined first position in the optical axis direction, and the O-ring is compressed in the optical axis direction at a position adjacent to the annular wall surface in a radial direction and exerts an urging force to urge the third lens toward the object side and to urge the second lens toward the first lens. With this configuration, release of the fitted state between the fitting portion of the second lens and the fitted portion of the first lens can be prevented or suppressed.

In the lens unit according to at least an embodiment of the present invention, a fitting portion is provided on a surface on an image side of the second lens. On the first lens located on the image side, a fitted portion to which the fitting portion is fitted from the object side is provided. Further, the first lens is supported at the first position in the optical axis direction. Furthermore, the first lens is positioned in the radial direction by a plurality of first fitting protrusions protruding from the first inner peripheral-surface portion on the inner peripheral surface of the lens barrel. Here, the second inner peripheral-surface portion located on the outer side in the radial direction of the second lens on the inner peripheral surface of the lens barrel has guide protrusions which guide the second lens in the optical axis direction provided at a plurality of spots separated in the circumferential direction. Therefore, when the second lens is inserted into the lens barrel from the object side after the first lens is accommodated in the lens barrel and positioned in the optical axis direction and the radial direction, the second lens is guided in the optical axis direction by the guide protrusions, and the fitting portion of the second lens is fitted to the fitted portion of the first lens. Thus, according to the lens unit of at least an embodiment of the present invention, the positional accuracy between the lenses can be improved by fitting these two lenses while accommodating the two lenses in the lens barrel.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is an appearance perspective view of a lens unit to which at least an embodiment of the present invention is applied;

FIG. 2 is a cross-sectional view of the lens unit;

FIG. 3 is an exploded perspective view of the lens unit;

FIG. 4 is an exploded perspective view of a lens L3 and a lens L4 when viewed from an object side;

FIG. 5 is an exploded perspective view of the lens L3 and the lens L4 when viewed from an image side;

FIG. 6 is an exploded perspective view of a lens L5 and a lens L6 when viewed from the object side;

FIG. 7 is an exploded perspective view of the lens L5 and the lens L6 when viewed from the image side;

FIG. 8 is a perspective view of a holder, the lens L5, and the lens L6;

FIG. 9 is a sectional view of a first lens barrel;

FIG. 10 is a perspective view of a second lens barrel viewed from the object side;

FIG. 11 is a sectional view of the second lens barrel; and

FIG. 12 is an explanatory diagram of a method of aligning the lens L6 and the lens L5.

### DETAILED DESCRIPTION

Hereinafter, embodiments of a lens unit to which at least an embodiment of the present invention is applied will be described with reference to the drawings.

### Optical System

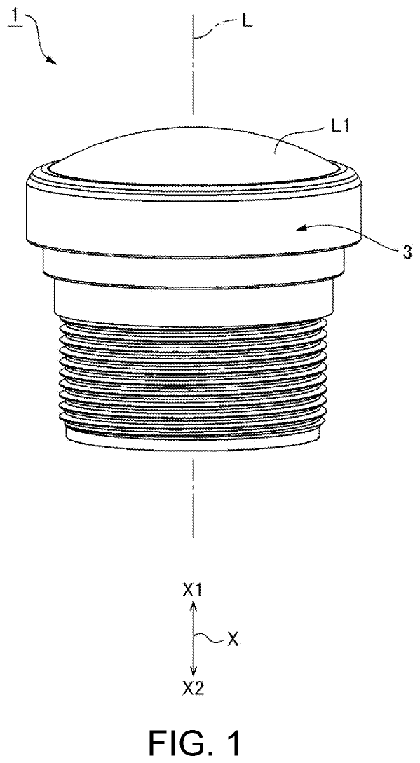

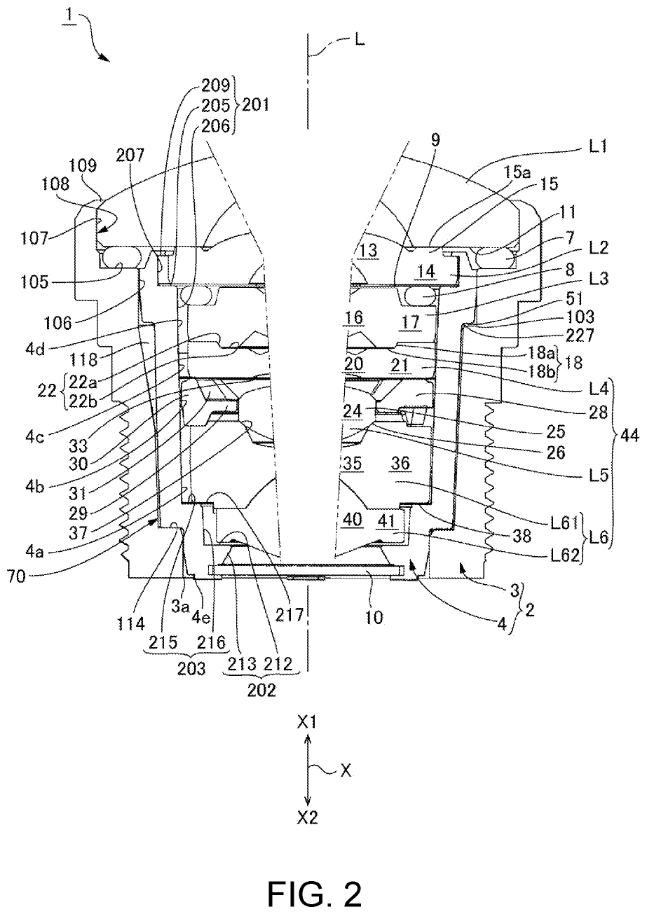

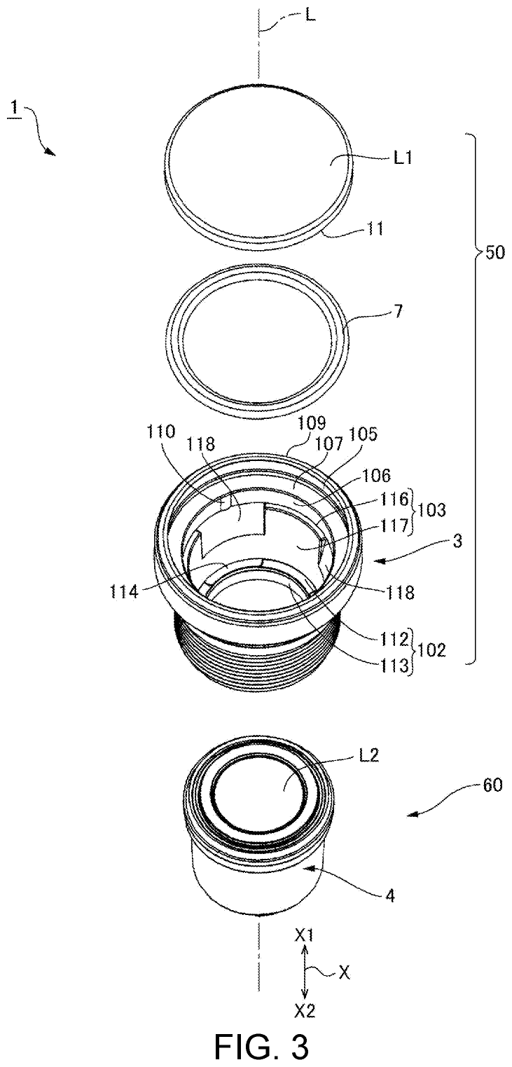

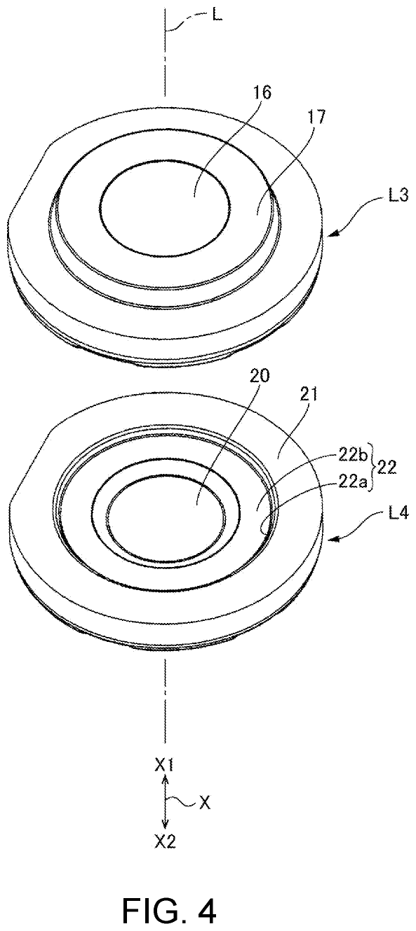

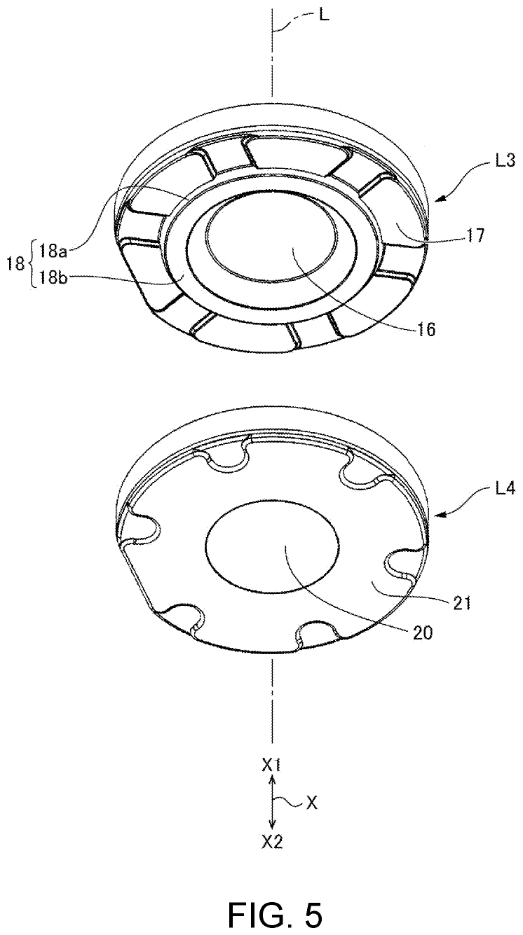

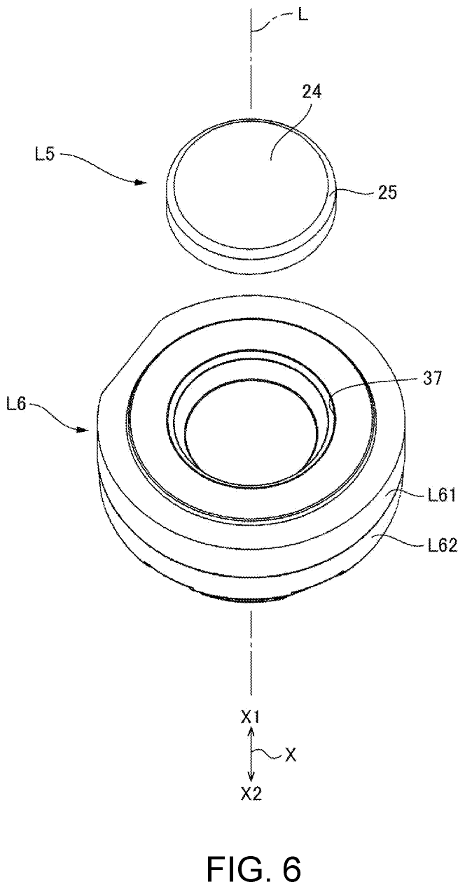

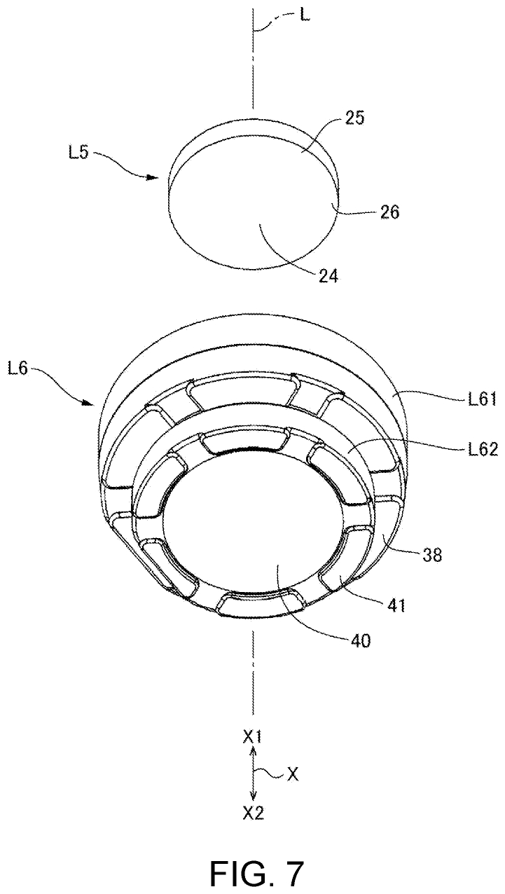

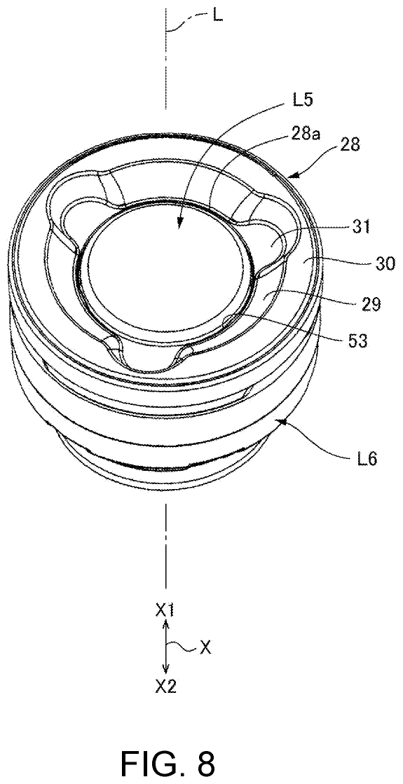

FIG. 1 is an appearance perspective view of a lens unit to which at least an embodiment of the present invention is applied. FIG. 2 is a cross-sectional view of the lens unit. FIG. 3 is an exploded perspective view of the lens unit. FIG. 4 is an exploded perspective view of a lens L3 and a lens L4 when viewed from an object side. FIG. 5 is an exploded perspective view of the lens L3 and the lens L4 when viewed from an image side. FIG. 6 is an exploded perspective view of a lens L5 and a lens L6 when viewed from the object side. FIG. 7 is an exploded perspective view of the lens L5 and the lens L6 when viewed from the image side. FIG. 8 is a perspective view of a holder, the lens L5, and the lens L6. It is to be noted that, in FIG. 2, a shape of each lens in a region (around the optical axis) between two two-dot chain lines is omitted.

A lens unit 1 of this Embodiment shown in FIG. 1 is used in an image pickup apparatus mounted on an automobile or a surveillance camera. As shown in FIG. 2, the lens unit 1 includes a lens L1, a lens L2, a lens L3, a lens L4, a lens L5, and a lens L6 in this order from the object side to the image side. The lens L6 is a cemented lens and includes an object-side lens L61 and an image-side lens L62 in this order from the object side to the image side. Further, the lens unit 1 includes, as a lens barrel 2, a first lens barrel 3 and a second lens barrel 4 held on an inner peripheral side of the first lens barrel 3. The lens L1 is accommodated in the first lens barrel 3. The lens L2 to the lens L6 are accommodated in the second lens barrel 4. The second lens barrel 4 is held on the inner peripheral side of the first lens barrel 3.

As shown in FIG. 3, the lens L1 and the first lens barrel 3 constitute a first unit 50. The lens L2 to the lens L6 and the second lens barrel 4 constitute a second unit 60. Hereinafter, a direction along the optical axis L of the lens L1 is referred to as an optical axis direction X. The optical axis L of the lens L1 is the optical axis L of the lens unit 1. An object side X1 in the optical axis direction X is a side where the lens L1 is located, and an image side X2 is a side where the lens L6 is located.

As shown in FIG. 2, the lens L1 has an outer diameter dimension larger than those of the lens L2 to the lens L6. In this Embodiment, the lens L1 is made of glass. The lens L1 is a meniscus-shaped lens having a convex shape on the object side X1. The lens L1 includes an annular end surface 11 spreading in a direction orthogonal to the optical axis L on the outer peripheral side of the lens surface on the image side X2. On the image side X2 of the end surface 11 of the lens L1, a first O-ring 7 is disposed.

The lens L2 is made of a resin. The lens L2 includes a lens main-body portion 13 having a lens surface and a flange portion 14 surrounding the lens main-body portion 13. The lens L2 is a meniscus lens having a convex shape on the object side X1. An annular protrusion 15 protruding toward the object side X1 is provided on an end surface of the object side X1 of the flange portion 14. A distal end of the annular protrusion 15 is an annular contact portion 15a in surface contact with the end surface of the lens L1.

As shown in FIGS. 2, 4, and 5, the lens L3 is made of a resin. The lens L3 includes a lens main-body portion 16 having a lens surface and a flange portion 17 surrounding the lens main-body portion 16. The lens L3 is a meniscus lens having a convex shape on the image side X2. As shown in FIG. 5, an annular fitting portion 18 protruding toward the object side X1 is provided on the end surface of the image side X2 of the flange portion 17. The fitting portion 18 includes a fitting-portion tapered surface 18a surrounding the optical axis L and inclined to the inner peripheral side toward the image side X2 and a fitting-portion end surface 18b extending perpendicularly to the optical axis L toward the inner peripheral side from an end on the image side X2 of the fitting-portion tapered surface 18a.

Here, as shown in FIG. 2, an elastic member is disposed between the lens L2 and the lens L3 in the optical axis direction X. The elastic member is a second O-ring 8. The second O-ring 8 is compressed in the optical axis direction X between the flange portion 14 of the lens L2 and the flange portion 17 of the lens L3. In this Embodiment, a light shielding sheet 9 made of a resin is disposed between the lens L1 and the lens L2 in the optical axis direction X. The light shielding sheet 9 has an annular shape. The second O-ring 8 is located between the light shielding sheet 9 and the lens L3.

The lens L4 is made of a resin. As shown in FIGS. 2, 4, and 5, the lens L4 includes a lens main-body portion 20 having a lens surface and a flange portion 21 surrounding the lens main-body portion 20. The lens surface on the object side X1 of the lens main-body portion 20 of the lens L4 is a curved surface protruding toward the object side X1. The lens surface on the object side X1 of the lens main-body portion 20 includes a curved surface part protruding toward the image side X2 at a center.

As shown in FIG. 4, a fitted portion 22 in which the fitting portion 18 of the lens L3 is fitted is provided on the end surface on the object side X1 of the flange portion 21. The fitting portion 18 includes a fitted-portion tapered surface 22a surrounding the optical axis L and inclined to the inner peripheral side toward the image side X2 and a fitted-portion end surface 22b extending perpendicularly to the optical axis L toward the inner peripheral side from an end on the image side X2 of the fitted-portion tapered surface 22a. As shown in FIG. 2, the fitting-portion tapered surface 18a of the lens L3 and the fitted-portion tapered surface 22a of the lens L4 are in surface contact with each other. The fitting-portion end surface 18b of the lens L3 and the fitted-portion end surface 22b of the lens L4 are separated in the optical axis direction X. In this Embodiment, the end surface on the image side X2 of the outer peripheral-side portion of the fitting portion 18 in the flange portion 17 of the lens L3 and the end surface on the object side X1 of the outer peripheral-side portion of the fitted portion 22 in the flange portion 21 of the lens L4 are in contact with each other in the optical axis direction X. As a result, the lens L3 is placed on the lens L4, and the lens L3 is positioned in the optical axis direction X.

The lens L5 is made of glass. As shown in FIG. 2, the lens L5 has an outer diameter dimension smaller than those of the lens L2, the lens L3, the lens L4, and the lens L6. The lens L5 includes a lens main-body portion 24 having a lens surface and a flange portion 25 surrounding the lens main-body portion 24. The lens L5 is a biconvex lens. As shown in FIGS. 2 and 7, the image side X2 of the flange portion 25 is also a contact portion 26 that comes into contact with the lens L6 from the object side X1. A cross section of the contact portion 26 cut along the optical axis Lis an arc curved to the object side X1 toward the outer peripheral side. As shown in FIG. 7, the surface on the image side X2 of the contact portion 26 continues to the outer peripheral end of a lens surface 24a on the image side X2 of the lens main-body portion 24 without a gap.

As shown in FIG. 2, a holder 28 made of a resin is disposed on the outer side in the radial direction the lens L5. As shown in FIG. 8, the holder 28 has an annular shape. The holder 28 includes a center portion 29 adjacent to the lens L5 with a clearance 28a in the radial direction and an outer peripheral portion 30 thicker in the optical axis direction X than the center portion 29 on the outer peripheral side of the center portion 29. A surface on the object side X1 of the center portion 29 is inclined to the image side X2 from the outer peripheral portion 30 toward the inner peripheral side. At three spots in the circumferential direction of the center portion 29 and the outer peripheral portion 30, notch portions 31 cut out from the object side X1 and the inner peripheral side are provided. A bottom surface (surface facing the object side X1) of the notch portion 31 continues to an end edge on the inner peripheral side of the center portion 29.

Here, a diaphragm 33 is disposed between the lens L4 and the lens L5. The diaphragm 33 is an annular sheet, is sandwiched between the lens L4 and the holder 28, and is supported at a predetermined position in the optical axis direction X.

The lens L6 is made of a resin. That is, both the object-side lens L61 and the image-side lens L62 are made of resins. As shown in FIG. 2, the object-side lens L61 includes a lens main-body portion 35 having a lens surface and a flange portion 36 surrounding the lens main-body portion 35. The lens surface on the object side X1 of the object-side lens L61 is a curved surface that curves toward the image side X2, and the lens surface on the image side X2 is a curved surface that is recessed toward the object side X1.

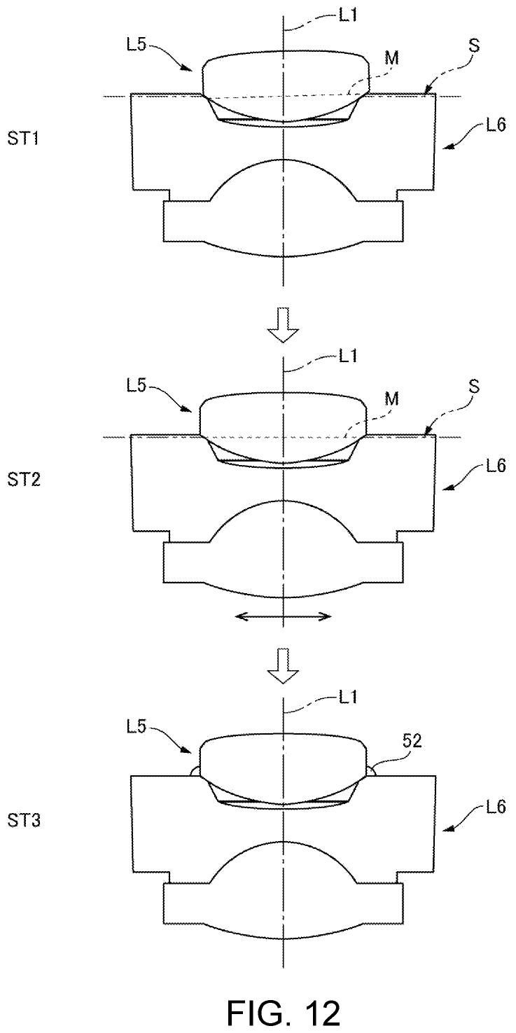

As shown in FIG. 6, the flange portion 36 of the object-side lens L61 includes a contacted portion 37 with which the contact portion 26 of the lens L5 comes into contact on the object side X1. The contacted portion 37 is a tapered surface extending to the object side X1 toward the outer peripheral side. The contact portion 26 and the contacted portion 37 are in linear contact. A contact line M along which the contact portion 26 and the contacted portion 37 come into contact with each other has an annular shape coaxial with the optical axis L and is located on a virtual perpendicular plane S perpendicular to the optical axis L (see FIG. 12 to be described later). Further, the flange portion 36 of the object-side lens L61 has an annular end surface 38 perpendicular to the optical axis L on the image side X2.

The image-side lens L62 includes a lens main-body portion 40 having a lens surface and a flange portion 41 surrounding the lens main-body portion 40. The lens surface on the object side X1 of the image-side lens L62 is a curved surface that protrudes toward the object side X1, and the lens surface on the image side X2 is a curved surface that protrudes toward the object side X1. The image-side lens L62 is fixed to the object-side lens L61. The outer diameter dimension of the image-side lens L62 is smaller than the outer diameter dimension of the object-side lens L61. Therefore, as shown in FIG. 7, when viewed from the image side X2, the flange portion 36 of the object-side lens L61 has a portion protruding from the image-side lens L62 to the outer peripheral side.

Here, as shown in FIG. 2, the lens L5 is stacked on the lens L6. Further, the lens L4 is stacked on the lens L6 via the holder 28. The lens L4, the holder 28, the lens L5, and the lens L6 constitute a laminated body 44. The lens L3 is stacked on the lens L4. That is, the lens L3 is stacked on the laminated body 44. Further, a plate-shaped cover 10 is disposed on the image side X2 of the lens L6.

### Lens Barrel

As shown in FIGS. 2 and 3, the lens unit 1 includes, as the lens barrel 2, the first lens barrel 3 and the second lens barrel 4 held on the inner peripheral side of the first lens barrel 3. The first lens barrel 3 and the second lens barrel 4 are both made of a resin. Further, the first lens barrel 3 and the second lens barrel 4 are resin-injection molded products molded by injecting a resin into a mold. The lens L1 is accommodated in the first lens barrel 3. The lenses L2 to L6 and the holder 28 are accommodated in the second lens barrel 4. The second lens barrel 4 is held on the inner peripheral side of the first lens barrel 3.

### First Lens Barrel and Lens L1

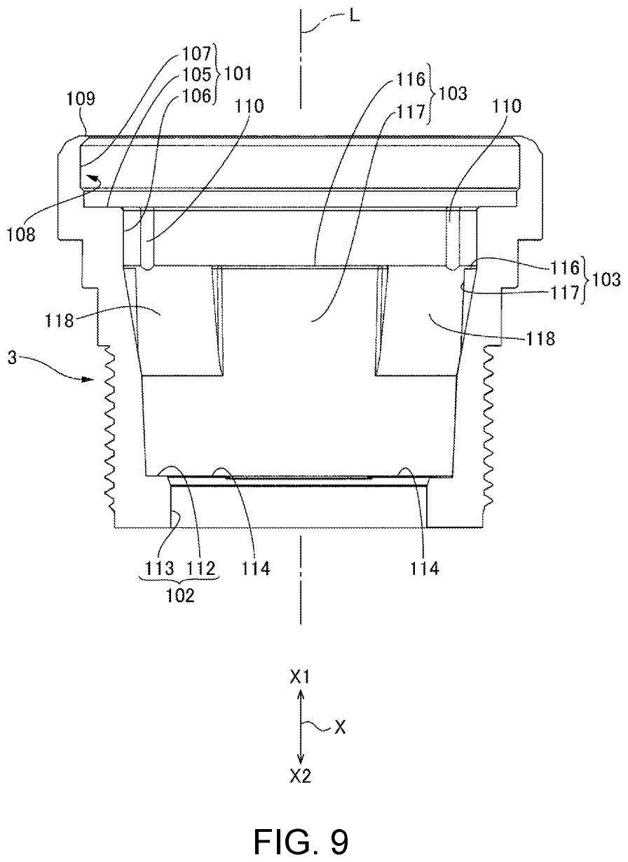

FIG. 9 is a sectional view of the first lens barrel 3. The first lens barrel 3 has a cylindrical shape and is located on the outer peripheral side of the lens L2, the lens L3, the lens L4, the holder 28, the lens L5, the lens L6, and the second lens barrel 4. As shown in FIGS. 3 and 9, the first lens barrel 3 includes an object-side stepped portion 101 at an end part on the object side X1 of the inner peripheral surface, and an image-side stepped portion 102 at an end part of the image side X2. Further, the first lens barrel 3 includes an intermediate stepped portion 103 between the object-side stepped portion 101 and the image-side stepped portion 102 in the optical axis direction X of the inner peripheral surface.

The object-side stepped portion 101 includes a support surface 105 facing the object side X1, an annular wall surface 106 extending from an end on an inner peripheral side of the support surface 105 toward the image side X2 and facing radially inward, and a peripheral wall surface 107 extending from an end on an outer peripheral side of the support surface 105 toward the object side X1. In the first lens barrel 3, the object side X1 of the object-side stepped portion 101 is an accommodating portion 108 that accommodates an outer peripheral-edge portion of the lens L1. It is to be noted that the second lens barrel 4 is held on the inner peripheral side of the annular wall surface 106.

The accommodating portion 108 includes the peripheral wall surface 107, the support surface 105, and a caulking portion 109. As shown in FIG. 2, the peripheral wall surface 107 faces the lens L1 from the outer side in the radial direction. The support surface 105 faces the end surface 11 of the lens L1 from the image side X2. The caulking portion 109 is brought into contact with the lens L1 from the object side X1 at a position overlapping the support surface 105 when viewed from the optical axis direction X along the optical axis L of the lens L1. The caulking portion 109 is a plastically deformed portion provided by thermal caulking or the like in which an end part of the object side X1 of the first lens barrel 3 is bent toward the inner peripheral side. Here, the outer peripheral-edge portion of the lens L1 is disposed between the support surface 105 and the caulking portion 109. The first O-ring 7 is disposed between the end surface on the image side X2 of the lens L1 and the support surface 105, and is compressed in the optical axis direction X.

As shown in FIG. 3, on the annular wall surface 106, object-side protrusions 110 protruding radially inward are provided at a plurality of spots in the circumferential direction. In this Embodiment, the object-side protrusions 110 are provided at three spots in the circumferential direction at equal angular intervals. The object-side protrusion 110 is an object-side positioning portion for positioning the second lens barrel 4 in the radial direction.

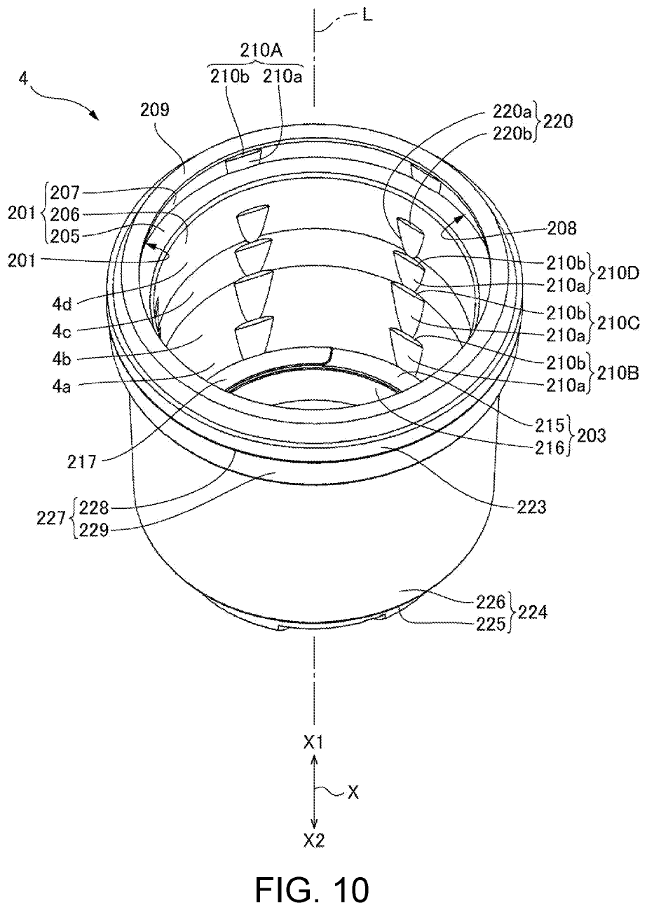

As shown in FIGS. 3 and 10, the image-side stepped portion 102 includes an annular image-side end surface 112 facing the object side X1, and an annular image-side inner-wall surface 113 extending from an end on the inner peripheral side of the image-side end surface 112 to the image side X2 and reaching an end on the image-side on the image side X2 of the first lens barrel 3. On the image-side end surface 112, a plurality of ribs 114 that protrude toward the object side X1 and extend in an arc shape in the circumferential direction are provided. In this Embodiment, the ribs 114 are provided at three spots in the circumferential direction at equal angular intervals. The rib 114 is an image-side positioning portion for positioning the second lens barrel 4 in the optical axis direction X.

The intermediate stepped portion 103 includes an annular stepped-portion end surface 116 facing the object side X1 and an annular stepped-portion wall surface 117 extending from an end on the inner peripheral side of the stepped-portion end surface 116 to the image side X2. In this Embodiment, in the intermediate stepped portion 103, notch grooves 118 which extend in the optical axis direction X and divide the stepped-portion end surface 116 and the stepped-portion wall surface 117 in the circumferential direction are provided at a plurality of spots in the circumferential direction. In this Embodiment, the notch grooves 118 are provided at three spots in the circumferential direction at equal angular intervals. Therefore, the intermediate stepped portion 103 is divided into three in the circumferential direction by the notch grooves 118. A bottom surface (surface facing the inner peripheral side) of the notch groove 118 is a tapered surface, and the inner diameter dimension becomes smaller toward the image side X2. As shown in FIG. 2, the bottom surface of the notch groove 118 continues to an inner peripheral-surface portion extending from the end on the outer peripheral side of the image-side end surface 112 of the image-side stepped portion 102 to the object side X1 on the inner peripheral surface of the first lens barrel 3.

Here, as shown in FIG. 3, the notch groove 118 is provided at the same angular position as the rib 114 of the image-side stepped portion 102. Further, the notch groove 118 is provided at the same angular position as that of the object-side protrusion 110 of the object-side stepped portion 101. It is to be noted that, when the first lens barrel 3 and the second lens barrel 4 disposed on the inner peripheral side of the first lens barrel 3 are connected to each other, an adhesive is applied to each of the stepped-portion end surfaces 116 of the intermediate stepped portion 103 divided into three. As a result, a lens-barrel connecting adhesive-layer 51 is provided on the stepped-portion end surface 116 and the stepped-portion wall surface 117.

### Second Lens Barrel and Lens L2 to Lens L6

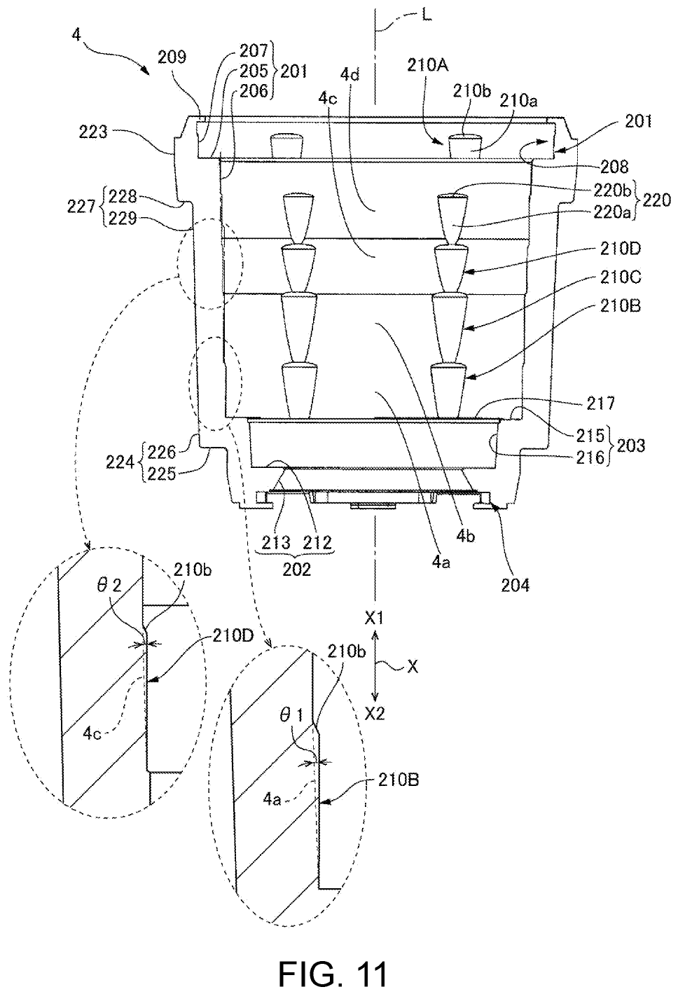

FIG. 10 is a perspective view of the second lens barrel 4 viewed from the object side. FIG. 11 is a sectional view of the second lens barrel 4. A region surrounded by a chain line in FIG. 11 is a partially enlarged view of a periphery of a fitting protrusion 210. The second lens barrel 4 accommodates the lens L2, the lens L3, the lens L4, the lens L5, the holder 28, and the lens L6 on the inner peripheral side.

As shown in FIGS. 10 and 11, the second lens barrel 4 includes an object-side stepped portion 201 at an end part on the object side X1 of the inner peripheral surface. Further, the second lens barrel 4 includes an image-side stepped portion 202 at an end part on the image side X2. Further, the second lens barrel 4 includes a positioning stepped portion 203 at a position between the object-side stepped portion 201 and the image-side stepped portion 202 and closer to the image-side stepped portion 202 than the object-side stepped portion 201. Further, the second lens barrel 4 includes a cover holding portion 204 that holds the cover 10 at an end part of the object side X1.

As shown in FIG. 11, the object-side stepped portion 201 includes a seating surface 205 facing the object side X1, an annular wall surface 206 extending from an end on the inner peripheral side of the seating surface 205 toward the image side X2, and a peripheral wall surface 207 extending from an end on the outer peripheral side of the seating surface 205 toward the object side X1. The annular wall surface 206 is a tapered surface whose inner diameter dimension becomes larger toward the object side X1. In the second lens barrel 4, the object side X1 of the object-side stepped portion 201 is an accommodating portion 208 that accommodates the outer peripheral-edge portion of the lens L2.

The accommodating portion 208 includes the peripheral wall surface 207, the seating surface 205, and a caulking portion 209. As shown in FIG. 2, the peripheral wall surface 207 faces the lens L2 from the outer side in the radial direction. The seating surface 205 faces the end surface on the image side X2 of the flange portion 14 of the lens L2 from the image side X2. The caulking portion 109 is brought into contact with the lens L2 from the object side X1 at a position overlapping the seating surface 205 when viewed from the optical axis direction X.

As shown in FIG. 10, the peripheral wall surface 207 is a tapered surface that is inclined from the seating surface 205 to the outer peripheral side toward the object side X1. The peripheral wall surface 207 includes fitting protrusions 210A to be pressure-joined to the lens L2 at a plurality of spots separated in the circumferential direction. In this Embodiment, the fitting protrusions 210A are provided at six spots in the circumferential direction at equal angular intervals. The fitting protrusion 210A includes a pressure-joining surface 210a parallel to the optical axis L at an end on the inner peripheral side. Further, the fitting protrusion 210A includes a curved surface 210b curved to the outer peripheral side from the pressure-joining surface 210a toward the object side X1. In the plurality of fitting protrusions 210A, the pressure-joining surface 210a is pressure-joined to the lens L2 accommodated in the accommodating portion 208 from the outer side in the radial direction so as to position the lens L2 in the radial direction.

As shown in FIG. 11, the image-side stepped portion 202 includes an annular image-side end surface 212 facing the object side X1, and an image-side inner-wall surface 213 extending from the end on the inner peripheral side of the image-side end surface 212 toward the image side X2. The image-side inner-wall surface 213 is a tapered surface that is inclined to the outer peripheral side toward the image side X2. As shown in FIG. 2, the image-side end surface 212 faces the image-side lens L62 of the lens L6 with a clearance therebetween in the optical axis direction X. The cover holding portion 204 is provided on the outer peripheral side of the image-side inner-wall surface 213.

As shown in FIGS. 10 and 11, the positioning stepped portion 203 includes an annular positioning surface 215 facing the object side X1, and a positioning stepped-portion peripheral-wall surface 216 extending from an end on the inner peripheral side of the positioning surface 215 toward the image side X2. On the positioning surface 215, a plurality of positioning ribs 217 that protrude toward the object side X1 and extend in an arc shape in the circumferential direction are provided. In this Embodiment, the positioning ribs 217 are provided at three spots in the circumferential direction at equal angular intervals. The lower end of the positioning stepped-portion peripheral-wall surface 216 reaches the image-side end surface 212 of the image-side end surface 212. The positioning stepped-portion peripheral-wall surface 216 is opposed to the image-side lens L62 of the lens L6 with a clearance in the radial direction.

As shown in FIG. 2, the positioning rib 217 is a positioning portion for positioning the lens L6 in the optical axis direction X by coming into contact with the flange portion 36 of the object-side lens L61 of the lens L6 from the image side X2. Here, the flange portion 36 of the object-side lens L61 of the lens L6 comes into contact with the positioning portion so that the laminated body 44 including the lens L4, the holder 28, the lens L5, and the lens L6 as well as the lens L3 are positioned in the optical axis direction X.

More specifically, the holder 28 is positioned at a predetermined position in the optical axis direction X by being supported by the lens L6 from the image side X2. The lens L4 is positioned at a predetermined position in the optical axis direction X by being supported by the holder 28 from the image side X2. The lens L5 is positioned in the optical axis direction X and the radial direction by being brought into contact with the lens L6. The lens L3 is positioned in the optical axis direction X and the radial direction by being fitted to the lens L4. Here, when the lens L5 is positioned in the optical axis direction X and the radial direction, the lens L5 and the holder 28 do not come into contact with each other. When the lens L3 and the lens L4 are positioned in the optical axis direction X and the radial direction, the lens L3 and the second lens barrel 4 do not come into contact with each other. The lens L3, the lens L4, the holder 28, and the lens L5 are positioned between the object-side stepped portion 201 and the positioning stepped portion 203 in the optical axis direction X.

As shown in FIGS. 10 and 11, on the inner peripheral surface of the second lens barrel 4, an inner peripheral-surface portion 4a located on the outer side in the radial direction of the object-side lens L61 of the lens L6 is a tapered surface inclined to the outer peripheral side toward the object side X1. The inner peripheral-surface portion 4a includes fitting protrusions 210B to be pressure-joined to the lens L6 at a plurality of spots separated in the circumferential direction. The fitting protrusions 210B are provided at six spots in the circumferential direction at equal angular intervals. The fitting protrusion 210B includes the pressure-joining surface 210a parallel to the optical axis L at an end on the inner peripheral side. Further, the fitting protrusion 210B includes the curved surface 210b curved to the outer peripheral side from the pressure-joining surface 210a toward the object side X1. In the plurality of fitting protrusions 210B, the pressure-joining surface 210a is pressure-joined to the lens L6 accommodated in the second lens barrel 4 from the outer side in the radial direction so as to position the lens L6 in the radial direction.

Further, in the inner peripheral surface of the second lens barrel 4, an inner peripheral-surface portion 4b located on the outer side in the radial direction of the holder 28 is a tapered surface inclined to the outer peripheral side toward the object side X1. The inner peripheral-surface portion 4b includes fitting protrusions 210C to be pressure-joined to the lens L6 at a plurality of spots separated in the circumferential direction. The fitting protrusions 210C are provided at six spots in the circumferential direction at equal angular intervals. The fitting protrusion 210C includes the pressure-joining surface 210a parallel to the optical axis L at an end on the inner peripheral side. Further, the fitting protrusion 210C includes the curved surface 210b curved to the outer peripheral side from the pressure-joining surface 210a toward the object side X1. The plurality of the fitting protrusions 210C are pressure-joined by the pressure-joining surface 210a to the holder 28 accommodated in the second lens barrel 4 from the outer side in the radial direction so as to position the holder 28 in the radial direction.

Further, on the inner peripheral surface of the second lens barrel 4, an inner peripheral-surface portion 4c located on the outer side in the radial direction of the lens L4 is a tapered surface inclined to the outer peripheral side toward the object side X1. The inner peripheral-surface portion 4c includes fitting protrusions 210D to be pressure-joined to the lens L4 at a plurality of spots separated in the circumferential direction. The fitting protrusions 210D are provided at six spots in the circumferential direction at equal angular intervals. The fitting protrusion 210D includes the pressure-joining surface 210a parallel to the optical axis L at an end on the inner peripheral side. Further, the fitting protrusion 210D includes the curved surface 210b curved to the outer peripheral side from the pressure-joining surface 210a toward the object side X1. In the plurality of fitting protrusions 210D, the pressure-joining surface 210a is pressure-joined to the lens L4 accommodated in the second lens barrel 4 from the outer side in the radial direction so as to position the lens L4 in the radial direction.

Further, on the inner peripheral surface of the second lens barrel 4, an inner peripheral-surface portion 4d located on the outer side in the radial direction of the lens L3 is a tapered surface inclined to the outer peripheral side toward the object side X1. The inner peripheral-surface portion 4d located on the outer side in the radial direction of the lens L3 continues to the image side X2 of the annular wall surface 206 of the object-side stepped portion 201 without a step. The inner peripheral-surface portion 4d includes guide protrusions 220 which guide the lens L3 in the optical axis direction X at a plurality of spots separated in the circumferential direction. The guide protrusions 220 are provided at six spots in the circumferential direction at equal angular intervals. The guide protrusion 220 includes a guide surface 220a parallel to the optical axis L at an end on the inner peripheral side. Further, the guide protrusion 220 includes a curved surface 220b curved from the pressure-joining surface 210a to the outer peripheral side toward the object side X1. When the lens L3 is fitted to the lens L4, the plurality of guide protrusions 220 are located on the outer side in the radial direction of the lens L3, but the plurality of guide protrusions 220 and the lens L3 do not come into contact with each other. The guide surface 220a of each of the guide protrusions 220 and the lens L3 are opposed to each other with a slight clearance in the radial direction.

Here, the second O-ring 8 is disposed on the object side X1 of the plurality of guide protrusions 220 and on the inner side in the radial direction of the annular wall surface 206 of the object-side stepped portion 201. As shown in FIG. 2, the second O-ring 8 is compressed in the optical axis direction X between the lens L2 accommodated in the accommodating portion 208 and the lens L3.

As shown in FIG. 11, the first inclination angle θ1 at which the tapered inner peripheral-surface portion 4a located on the outer side in the radial direction of the lens L6 is inclined with respect to the optical axis Lis different from the second inclination angle θ2 at which the tapered inner peripheral-surface portion 4c located on the outer side in the radial direction of the lens L4 is inclined with respect to the optical axis L. That is, the inclination of the inner peripheral-surface portions 4a to 4d located on the outer side in the radial direction of each lens and the holder 28 can be set as appropriate in accordance with the outer diameter dimension of each lens or the holder 28. It is to be noted that, in the inner peripheral surface of the second lens barrel 4, the inner peripheral-surface portion 4a located between the object-side stepped portion 201 and the positioning stepped portion 203 is inclined to the outer peripheral side toward the object side X1 as a whole.

Subsequently, the second lens barrel 4 includes an annular outer peripheral-surface-side positioning surface 223 at an end part on the object side X1 of the outer peripheral surface. The outer peripheral-surface-side positioning surface 223 is located on the outer side in the radial direction of the accommodating portion 208. The outer peripheral-surface-side positioning surface 223 faces the outer side in the radial direction. Further, the second lens barrel 4 includes an outer peripheral-surface image-side stepped portion 224 on the image side X2 part of the outer peripheral surface. The outer peripheral-surface image-side stepped portion 224 includes an annular surface 225 facing the image side X2 and an outer peripheral-surface portion 226 extending from an outer peripheral end of the annular surface 225 to the object side X1. Further, the second lens barrel 4 includes an outer peripheral-surface intermediate stepped-portion 227 between an end part on the object side X1 on the outer peripheral surface (outer peripheral-surface-side positioning surface 223) and the outer peripheral-surface image-side stepped portion 224. The outer peripheral-surface intermediate stepped-portion 227 includes an annular surface 228 facing the image side X2 and an outer peripheral-surface portion 229 extending from an end on an inner peripheral side of the annular surface 228 to the image side X2.

### Assembly of Lens Unit

FIG. 12 is an explanatory diagram of a method of aligning the lens L6 and the lens L5. When the lens unit 1 is to be assembled, first, a second-unit assembling operation of accommodating the lenses L2 to L6 in the second lens barrel 4 is performed. Subsequently, a lens-barrel fixing operation for holding and fixing the second lens barrel 4 to the first lens barrel 3 is performed. Thereafter, a first-unit assembling operation for accommodating the lens L1 in the first lens barrel 3 is performed.

In the second-unit assembling operation, as shown in FIG. 12, first, the lens L5 is stacked on the lens L6 outside the second lens barrel 4, and the contact portion 26 of the lens L5 and the contacted portion 37 of the lens L6 are brought into line contact with each other (Step ST1). Thereafter, the lens L6 is vibrated until the annular contact line M along which the contact portion 26 and the contacted portion 37 are in contact with each other is positioned on the virtual perpendicular plane S which is coaxial with the optical axis L and perpendicular to the optical axis L (Step ST2). Here, when the annular contact line M on which the contact portion 26 and the contacted portion 37 are in contact with each other is positioned on the virtual perpendicular plane S which is coaxial with the optical axis L and perpendicular to the optical axis L, the lens L5 and the lens L6 are aligned. That is, the lens L5 and the lens L6 are relatively positioned in the optical axis direction X and the radial direction.

After the alignment is completed, an adhesive is applied between the lens L1 and the lens L2 on the outer peripheral side of the contact line M. Further, the adhesive is cured. As a result, the lens L6 and the lens L5 are fixed by an adhesive layer 52 formed between them (Step ST3).

Subsequently, the lens L5 and the lens L6 fixed to each other are accommodated in the second lens barrel 4 from the object side X1. At this time, as can be seen from FIG. 10, the lens L6 is press-fitted into the inner peripheral side of the plurality of fitting protrusions 210B provided the closest to the image side X2 on the inner peripheral surface of the second lens barrel 4. As a result, the pressure-joining surface 210a of each of the fitting protrusions 210B is pressure-joined to the lens L6 (object-side lens L61) from the outer side in the radial direction, and the lens L6 is positioned in the radial direction. Further, the flange portion 36 of the object-side lens L61 of the lens L6 is brought into contact with the positioning rib 217 of the positioning stepped portion 203 of the second lens barrel 4. As a result, the lens L6 is positioned in the optical axis direction X. When the lens L6 is positioned in the optical axis direction X and the radial direction, the lens L5 fixed to the lens L6 is also positioned in the optical axis direction X and the radial direction.

Thereafter, the holder 28 is accommodated in the second lens barrel 4 from the object side X1. At this time, the holder 28 is press-fitted to the inner peripheral side of the second plurality of fitting protrusions 210C from the image side X2 on the inner peripheral surface of the second lens barrel 4. As a result, the pressure-joining surface 210a of each fitting protrusion 210C is pressure-joined to the holder 28 from the outer side in the radial direction, and the holder 28 is positioned in the radial direction. Further, by bringing the holder 28 into contact with the lens L6 from the object side X1, the holder 28 is supported by the lens L6 from the image side X2 and is positioned in the optical axis direction X. Here, clearances 28a are formed between an inner peripheral surface of the holder 28 and the lens L5. Therefore, an adhesive is dropped into these clearances 28a to fix the holder 28 and the lens L5 via an adhesive layer 53 (see FIG. 8). In this Embodiment, the adhesive is applied to the notch portion 31 provided in an outer peripheral portion 30 of the holder 28. As a result, the adhesive reaches the clearances 28a between an inner peripheral surface of the holder 28 and the lens L5 along the center portion 29.

Thereafter, the lens L4 is accommodated in the second lens barrel 4 from the object side X1. At this time, the lens L4 is press-fitted to the inner peripheral side of the third plurality of fitting protrusions 210D from the image side X2 on the inner peripheral surface of the second lens barrel 4. As a result, the pressure-joining surface 210a of each fitting protrusion 210D is pressure-joined to the lens L4 from the outer side in the radial direction, and the lens L4 is positioned in the radial direction. Further, by bringing the lens L4 into contact with the holder 28 from the object side X1, the lens L4 is supported by the holder 28 from the image side X2, and is positioned in the optical axis direction X. Here, the laminated body 44 constituted by the lens L4, the holder 28, the lens L5, and the lens L6 is configured inside the second lens barrel 4.

Subsequently, the lens L3 is accommodated in the second lens barrel 4 from the object side X1. At this time, the lens L3 is inserted into the inner peripheral side of the plurality of guide protrusions 220. As a result, the lens L3 is guided in the optical axis direction X in a predetermined posture, and the fitting portion 18 of the lens L3 is inserted into the fitted portion 22 of the lens L4. Further, the lens L3 guided by the guide protrusion 220 is pushed into the lens L4 from the object side X1. As a result, the fitting portion 18 of the lens L3 and the fitted portion 22 of the lens L4 are fitted to each other. In a state where the fitting portion 18 of the lens L3 and the fitted portion 22 of the lens L4 are fitted to each other, the fitting-portion tapered surface 18a of the fitting portion 18 and the fitted-portion tapered surface 22a of the fitted portion 22 are in surface contact with each other. As a result, the lens L3 is positioned with respect to the lens L4 in the radial direction. Further, in a state where the fitting portion 18 of the lens L3 and the fitted portion 22 of the lens L4 are fitted to each other, an outer peripheral-side portion of the fitting portion 18 in the flange portion 17 of the lens L3 and an outer peripheral-side portion of the fitted portion 22 in the flange portion 21 of the lens L4 come into contact with each other in the optical axis direction X. As a result, the lens L3 is brought into a state positioned in the optical axis direction X.

Thereafter, the second O-ring 8 is placed on the flange portion 17 of the lens L3 from the object side X1. Subsequently, the light shielding sheet 9 is caused to be supported by the support surface 105. Further, the lens L2 is caused to be supported by the support surface 105 via the light shielding sheet 9. At this time, the lens L2 is press-fitted to the inner peripheral side of the fitting protrusion 210A located the closest to the object side X1 on the inner peripheral surface of the second lens barrel 4. As a result, the pressure-joining surface 210a of each fitting protrusion 210A is pressure-joined to the lens L2 from the outer side in the radial direction, and the lens L2 is positioned in the radial direction. Further, by bringing the lens L2 into contact with the light shielding sheet 9 from the object side X1, the lens L2 is positioned in the optical axis direction X.

Thereafter, the caulking portion 109 bent to the inner peripheral side is formed at the end part on the object side X1 of the second lens barrel 4, and the caulking portion 109 is brought into contact with the outer peripheral-edge portion of the lens L2 from the object side X1. In this Embodiment, the caulking portion 109 is formed by thermal caulking. As a result, a second-unit assembling operation is completed. In a state where the second-unit assembling operation is completed, the second O-ring 8 is compressed in the optical axis direction X between the lens L2 and the lens L3.

Subsequently, a lens-barrel fixing operation for causing the second unit 60 to be held by the first unit 50 is performed. In the lens-barrel fixing operation, as can be seen from FIGS. 3 and 9, an adhesive is applied to the stepped-portion end surface 116 of each of the three intermediate stepped portions 103 provided on the inner peripheral surface of the first lens barrel 3. Thereafter, the second unit 60 is inserted into the inner peripheral side of the first lens barrel 3 from the object side X1. Then, as can be seen from FIGS. 11 and 9, the annular surface 225 of the outer peripheral-surface image-side stepped portion 224 provided on the image-side part of the outer peripheral surface of the second lens barrel 4 is brought into contact with the rib 114 (image-side positioning portion) of the image-side stepped portion 102 provided on the inner peripheral surface of the first lens barrel 3. Further, the annular outer peripheral-surface-side positioning surface 223 provided on the end part of the object side X1 of the second lens barrel 4 is brought into contact with the object-side protrusion 110 provided on the annular wall surface 106 of the object-side stepped portion 101 of the first lens barrel 3.

Here, the inner peripheral surface of the first lens barrel 3 and the outer peripheral surface of the second lens barrel 4 are opposed to each other with a clearance except for a contact portion between the image-side stepped portion 102 of the second lens barrel 4 and the image-side stepped portion 102 of the first lens barrel 3 and a contact portion between the annular positioning surface 215 of the second lens barrel 4 and the object-side stepped portion 101 of the first lens barrel 3. Therefore, the second lens barrel 4 is positioned in the optical axis direction X and the radial direction with respect to the first lens barrel 3 by the two contact portions.

Further, when the second unit 60 is inserted into the inner peripheral side of the first lens barrel 3, the intermediate stepped portion 103 of the inner peripheral surface of the first lens barrel 3 and the outer peripheral-surface intermediate stepped-portion 227 of the outer peripheral surface of the second lens barrel 4 face each other with a clearance therebetween. That is, the stepped-portion end surface 116 of the intermediate stepped portion 103 of the first lens barrel 3 and the annular surface 228 of the outer peripheral-surface intermediate stepped-portion 227 of the second lens barrel 4 face each other with a clearance therebetween in the optical axis direction X. Further, the stepped-portion wall surface 117 of the intermediate stepped portion 103 of the first lens barrel 3 and the outer peripheral-surface portion 229 of the outer peripheral-surface intermediate stepped-portion 227 of the second lens barrel 4 face each other with a clearance in the radial direction. Here, the adhesive applied to the stepped-portion end surface 116 of the intermediate stepped portion 103 of the first lens barrel 3 spreads to the stepped-portion wall surface 117 when the second unit 60 is inserted into the inner peripheral side of the first lens barrel 3. Therefore, as shown in FIG. 2, the lens-barrel connecting adhesive-layer 51 is interposed between the stepped-portion end surface 116 of the intermediate stepped portion 103 of the first lens barrel 3 and the annular surface 228 of the outer peripheral-surface intermediate stepped-portion 227 of the second lens barrel 4. Further, the lens-barrel connecting adhesive-layer 51 is interposed between the stepped-portion wall surface 117 of the intermediate stepped portion 103 of the first lens barrel 3 and an outer peripheral-surface portion 229 of the outer peripheral-surface intermediate stepped-portion 227 of the second lens barrel 4. The intermediate stepped portion 103 of the first lens barrel 3 and the outer peripheral-surface intermediate stepped-portion 227 of the second lens barrel 4 are adhesive fixing portions that connect the first lens barrel 3 and the second lens barrel 4 via the lens-barrel connecting adhesive-layer 51.

Subsequently, in the first-unit assembly operation, the first O-ring 7 is placed on the support surface 105 of the first lens barrel 3. Thereafter, the lens L1 is caused to be supported by the support surface 105 via the first O-ring 7. Thereafter, the caulking portion 109 bent to the inner peripheral side is formed at the end part of the object side X1 of the first lens barrel 3. As a result, the caulking portion 109 is brought into contact with the outer peripheral-edge portion of the lens L1 from the object side X1. In this Embodiment, the caulking portion 109 is formed by thermal caulking. When the caulking portion 109 is formed, the first O-ring 7 is compressed in the optical axis direction X between the end surface on the image side X2 of the lens L1 and the support surface 105 of the first lens barrel 3.

Here, when the lens L1 is held by the first lens barrel 3, the annular protrusion 15 provided on the flange portion 14 of the lens L2 held by the second lens barrel 4 is in surface contact with the end surface 11 on the image side X2 of the lens L2.

Further, as shown in FIG. 2, between the first lens barrel 3 and the second lens barrel 4, an air passage 70 is formed from between an end 3a on the image side X2 of the first lens barrel 3 and an end 4e on the image side X2 of the second lens barrel 4 via between the ribs 114 adjacent to each other in the circumferential direction in the image-side stepped portion 102 of the first lens barrel 3, the notch groove 118 provided in the intermediate stepped portion 103 of the first lens barrel 3, and between the object-side protrusions 110 adjacent to each other in the circumferential direction on the annular wall surface 106 of the object-side stepped portion 101 of the first lens barrel 3. The air passage 70 communicates with a space between the lens L1 and the support surface 105 and closer to the inner peripheral side than the first O-ring 7.

### Operation and Effect

The lens unit 1 of this Embodiment includes a lens L4 (first lens) and a lens L3 (second lens) disposed in this order from the image side X2 toward the object side X1, and a second lens barrel 4 (lens barrel) that accommodates the lens L4 and the lens L3 on the inner peripheral side. The lens L3 includes a fitting portion 18 fitted to the lens L4 on the surface of the image side X2. The lens L4 is supported from the image side X2 at a predetermined first position in the optical axis direction X, and on the surface on the object side X1 of the lens L4, a fitted portion 22 to which the fitting portion 18 is fitted from the object side X1 is provided. On an inner peripheral-surface portion 4c (first inner peripheral-surface portion) located on an outer side in the radial direction of the lens L4 on the inner peripheral surface of the second lens barrel 4, fitting protrusions 210D (first fitting protrusions) which are pressure-joined to the lens L4 are provided at a plurality of spots separated in the circumferential direction. On an inner peripheral-surface portion 4d (second inner peripheral-surface portion) located on the outer side in the radial direction of the lens L3 on the inner peripheral surface of the second lens barrel 4, guide protrusions 220 that guide the lens L3 in the optical axis direction X at a plurality of spots separated in the circumferential direction are provided. The plurality of fitting protrusions 210D position the lens L4 in the radial direction, and the lens L4 is positioned in the radial direction with respect to the lens L3 by the fitting between the fitting portion 18 and the fitted portion 22.

In the lens unit 1 of this Embodiment, the fitting portion 18 is provided on the surface on the image side X2 of the lens L3 located on the object side X1 of the two lenses. On the other hand, on the lens L4 located on the image side X2, the fitted portion 22 to which the fitting portion 18 is fitted from the object side X1 is provided. Further, the lens L4 is supported at the predetermined first position in the optical axis direction X. Furthermore, the lens L4 is positioned in the radial direction by a plurality of the fitting protrusions 210D protruding from the inner peripheral-surface portion 4c on the inner peripheral surface of the second lens barrel 4. Here, the inner peripheral-surface portion 4d located on the outer side in the radial direction of the lens L3 on the inner peripheral surface of the second lens barrel 4 includes guide protrusions 220 which guide the lens L3 in the optical axis direction X at a plurality of spots separated in the circumferential direction. Therefore, when the lens L3 is inserted into the second lens barrel 4 from the object side X1 after the lens L4 is accommodated in the second lens barrel 4 and positioned in the optical axis direction X and the radial direction, the lens L3 is guided by the guide protrusions 220 in the optical axis direction, and the fitting portion 18 of the lens L3 is inserted into the fitted portion 22 of the lens L4. Further, since the lens L3 is guided by the guide protrusions 220 in the optical axis direction X, the fitting portion 18 and the fitted portion 22 can be fitted to each other by pushing the lens L3 into the lens L4 from the object side X1 in the optical axis direction X. Thus, according to the lens unit 1 of this Embodiment, the positional accuracy between the lenses can be improved by fitting these two lenses while accommodating the two lenses in the second lens barrel 4.

In this Embodiment, the fitting portion 18 includes a fitting-portion tapered surface 18a surrounding the optical axis L and inclined to the inner peripheral side toward the image side X2. The fitted portion 22 includes a fitted-portion tapered surface 22a surrounding the optical axis L and inclined to the outer peripheral side toward the object side X1. When the fitting portion 18 and the fitted portion 22 are fitted to each other, the fitting-portion tapered surface 18a and the fitted-portion tapered surface 22a come into surface contact with each other. With this configuration, the lens L4 and the lens L3 can be fitted by pushing in the lens L3 toward the lens L4 from the object side X1. Further, the fitting-portion tapered surface 18a and the fitted-portion tapered surface 22a come into surface contact with each other, whereby the lens L4 and the lens L3 are positioned with respect to each other in the optical axis direction X and the radial direction.

Further, in this Embodiment, in a state where the fitting portion 18 and the fitted portion 22 are fitted to each other, a clearance is provided between the lens L3 and the plurality of guide protrusions 220. Therefore, it is possible to prevent the guide protrusion provided on the second lens barrel 4 and the lens L3 from interfering with each other, whereby lowering of the positional accuracy between the lens L4 and the lens L3 can be prevented.

In this Embodiment, the second lens barrel 4 is made of a resin. The inner peripheral-surface portion 4c is a tapered surface inclined to the outer peripheral side toward the object side X1. The fitting protrusion 210D includes the pressure-joining surface 210a parallel to the optical axis L at an end on the inner peripheral side. The lens L4 is positioned in the radial direction by the fitting protrusion 210D protruding from the inner peripheral-surface portion 4c of the second lens barrel 4 made of a resin. When the inner peripheral-surface portion 4c is defined as a tapered surface inclined to the outer peripheral side toward the object side X1, the inner peripheral-surface portion 4c includes a “draft angle” which makes it easy to separate the mold and the second lens barrel 4 in the optical axis direction X of the lens L4 (the axial direction of the second lens barrel 4) at the time of mold release for separating the mold and the second lens barrel 4 at the time of resin molding. As a result, since generation of stress in the second lens barrel 4 at the time of mold release can be suppressed, the generation of distortion in the second lens barrel 4 due to this stress can be prevented or suppressed. Therefore, it is possible to prevent or suppress lowering of the positional accuracy of the lens L4 held by the second lens barrel 4. Further, the lens L4 and the fitting protrusion 210D are pressure-joined by surfaces. Therefore, inclination of the lens L4 with respect to the optical axis L can be prevented or suppressed.

In this Embodiment, the inner peripheral-surface portion 4d is a tapered surface inclined to the outer peripheral side toward the object side X1, and the guide protrusion 220 includes a guide surface 220a parallel to the optical axis L at an end on the inner peripheral side. With this configuration, the inner peripheral-surface portion 4d includes a “draft angle” which makes it easy to separate the mold and the second lens barrel 4 in the optical axis direction X at the time of mold release for separating the mold and the second lens barrel 4 at the time of resin-molding. As a result, since generation of stress in the second lens barrel 4 at the time of mold release can be suppressed, the generation of distortion in the second lens barrel 4 due to this stress can be prevented or suppressed. Further, when the guide protrusion 220 includes a guide surface 220a parallel to the optical axis L at the end on the inner peripheral side, the lens L3 can be guided easily in the optical axis direction without being inclined to the optical axis L.

In this Embodiment, the lens L2 (third lens) disposed on the object side X1 of the lens L3 and a second O-ring 8 (O-ring) disposed between the lens L2 and the lens L3 are provided. The second lens barrel 4 accommodates the lens L3 and the second O-ring 8. Further, the second lens barrel 4 includes an annular caulking portion 209 which is bent from the distal end part of the object side X1 to the inner peripheral side and is brought into contact with the outer peripheral-end portion of the lens L3 from the object side X1 and also includes an object-side stepped portion 201 (first stepped portion) on the inner peripheral surface, and the object-side stepped portion 201 includes an annular seating surface 205 (seating surface) facing the object side X1 at a position overlapping a caulking portion 109 when viewed from the optical axis direction X and an annular wall surface 206 (annular wall surface) extending from the end on the inner peripheral side of the seating surface 205 to the image side X2. An outer peripheral-edge portion of the lens L3 is located between the caulking portion 109 and the seating surface 205, and the lens L4 is laminated on the lens 6 and the holder 28 and is supported from the image side X2 at a predetermined position (first position) in the optical axis direction X. The second O-ring 8 is compressed in the optical axis direction X at a position adjacent to the annular wall surface 206 in the radial direction and exerts an urging force to urge the lens L3 toward the object side X1 and to urge the lens L3 toward the lens L4. In this Embodiment, the lens L3 is urged against the lens L4. Therefore, release of the fitted state between the fitting portion 18 of the lens L3 and the fitted portion 22 of the lens L4 can be prevented or suppressed.

### Variation

It is to be noted that, when the fitting portion 18 of the lens L3 and the fitted portion 22 of the lens L4 are fitted to each other, the end surface on the image side X2 of the outer peripheral-side portion of the fitting portion 18 in the flange portion 17 of the lens L3 and the end surface on the image side X2 of the outer peripheral-side portion of the fitted portion 22 in the flange portion 21 of the lens L4 may have such dimensional relation not in contact with each other in the optical axis direction X. In this case, when the fitting portion 18 of the lens L3 and the fitted portion 22 of the lens L4 are fitted to each other and the fitting-portion tapered surface 18a of the fitting portion 18 and the fitted-portion tapered surface 22a of the fitted portion 22 are brought into surface contact with each other, the lens L3 can be positioned with respect to the lens L4 in the radial direction and the optical axis direction.

Further, the fitting portion 18 of the lens L3 may include a fitting-portion tapered surface surrounding the optical axis L and inclined to the outer peripheral side toward the image side X2, and the fitted portion 22 of the lens L4 may include a fitted-portion tapered surface 22a surrounding the optical axis L and inclined to the inner peripheral side toward the object side X1.

It to be noted that the present art can have a configuration as follows.
(1) A lens unit characterized by including a first lens and a second lens disposed in this order from an image side to an object side, and a lens barrel which accommodates the first lens and the second lens on an inner peripheral side, in which the second lens includes a fitting portion which is fitted to the first lens on a surface on the image side, and when a direction along an optical axis of the first lens is defined as an optical axis direction, the first lens is supported from the image side at a predetermined first position in the optical axis direction, on a surface of the first lens on the object side, a fitted portion to which the fitting portion is fitted from the object side is provided, a first inner peripheral-surface portion located on an outer side in a radial direction of the first lens on an inner peripheral surface of the lens barrel includes first fitting protrusions which are pressure-joined to the first lens at a plurality of spots separated in a circumferential direction, a second inner peripheral-surface portion located on the outer side in the radial direction of the second lens on the inner peripheral surface of the lens barrel includes guide protrusions which guide the second lens in the optical axis direction at a plurality of spots separated in the circumferential direction, a plurality of the first fitting protrusions position the first lens in the radial direction, and the first lens is positioned in the radial direction with respect to the second lens by fitting of the fitting portion and the fitted portion.
(2) The lens unit described in (1), in which the fitting portion includes a fitting-portion tapered surface surrounding the optical axis and inclined to an inner peripheral side toward the image side, the fitted portion includes a fitted-portion tapered surface surrounding the optical axis and inclined to an outer peripheral side toward the object side, and when the fitting portion and the fitted portion are fitted to each other, the fitting-portion tapered surface and the fitted-portion tapered surface come into surface contact with each other.
(3) The lens unit described in (1) or (2), in which a clearance is provided between the second lens and a plurality of the guide protrusions in a state where the fitting portion and the fitted portion are fitted to each other.
(4) The lens unit described in any one of (1) to (3), in which the lens barrel is made of a resin, the first inner peripheral-surface portion is a tapered surface inclined to an outer peripheral side toward the object side, and the first fitting protrusion includes a pressure-joining surface which is parallel to the optical axis at an end on an inner peripheral side.
(5) The lens unit described in (4), characterized in that the second inner peripheral-surface portion is a tapered surface inclined to the outer peripheral side toward the object side, and the guide protrusion includes a guide surface parallel to the optical axis at an end on the inner peripheral side.
(6) The lens unit described in any one of (1) to (5), characterized by having a third lens disposed on the object side of the second lens, and an O-ring disposed between the second lens and the third lens, in which the third lens and the O-ring are accommodated in the lens barrel; the lens barrel includes an annular caulking portion which is bent to an inner peripheral side and is brought into contact with an outer peripheral-end portion of the third lens from the object side on an end part on the object side and a first stepped portion on an inner peripheral surface; the first stepped portion includes an annular seating surface facing the object side at a position overlapping the caulking portion when viewed from the optical axis direction and an annular wall surface extending from an end on an inner peripheral side of the seating surface to the image side; an outer peripheral-edge portion of the third lens is located between the caulking portion and the seating surface; the first lens is supported from the image side at a predetermined first position in the optical axis direction; and the O-ring is compressed in the optical axis direction at a position adjacent to the annular wall surface in the radial direction and exerts an urging force to urge the third lens toward the object side and to urge the second lens toward the first lens.

What is claimed is:

1. A lens unit comprising:
a first lens and a second lens disposed in this order from an image side toward an object side; and
a lens barrel which accommodates the first lens and the second lens on an inner peripheral side, wherein
the second lens includes a fitting portion fitted to the first lens on a surface on the image side;
when a direction along an optical axis of the first lens is defined as an optical axis direction, the first lens is supported from the image side at a predetermined first position in the optical axis direction;
a fitted portion to which the fitting portion is fitted from the object side is provided on a surface on the object side of the first lens;
a first inner peripheral-surface portion located on an outer side in a radial direction of the first lens on the inner peripheral surface of the lens barrel includes first fitting protrusions which are pressure-joined to the first lens at a plurality of spots separated in a circumferential direction;
a second inner peripheral-surface portion located on the outer side in the radial direction of the second lens on the inner peripheral surface of the lens barrel includes guide protrusions which guide the second lens in the optical axis direction at a plurality of spots separated in the circumferential direction;
a plurality of the first fitting protrusions position the first lens in the radial direction; and
the first lens is positioned in the radial direction with respect to the second lens by fitting of the fitting portion and the fitted portion.

2. The lens unit according to claim 1, wherein the fitting portion includes a fitting-portion tapered surface which surrounds the optical axis and is inclined to an inner peripheral side toward the image side;
the fitted portion includes a fitted-portion tapered surface which surrounds the optical axis and is inclined to an outer peripheral side toward the object side; and
when the fitting portion and the fitted portion are fitted to each other, the fitting-portion tapered surface and the fitted-portion tapered surface come into surface contact with each other.

3. The lens unit according to claim 1, wherein a clearance is provided between the second lens and a plurality of the guide protrusions in a state in which the fitting portion and the fitted portion are fitted to each other.

4. The lens unit according to claim 1, wherein the lens barrel is made of a resin;
the first inner peripheral-surface portion is a tapered surface inclined to an outer peripheral side toward the object side; and
the first fitting protrusion includes a pressure-joining surface parallel to the optical axis at an end on an inner peripheral side.

5. The lens unit according to claim 4, wherein the second inner peripheral-surface portion is a tapered surface inclined to the outer peripheral side toward the object side; and
the guide protrusion includes a guide surface parallel to the optical axis at an end on an inner peripheral side.

6. The lens unit according to claim 1, further comprising:
a third lens disposed on the object side of the second lens; and
an O-ring disposed between the second lens and the third lens, wherein
the third lens and the O-ring are accommodated in the lens barrel;
the lens barrel includes an annular caulking portion which is bent to an inner peripheral side and is brought into contact with an outer peripheral-end portion of the third lens from the object side on an end part on the object side and a first stepped portion on an inner peripheral surface;
the first stepped portion includes an annular seating surface facing the object side at a position overlapping the caulking portion when viewed from the optical axis direction and an annular wall surface extending from an end on an inner peripheral side of the annular seating surface to the image side;
an outer peripheral-edge portion of the third lens is located between the caulking portion and the seating surface;
the first lens is supported from the image side at a predetermined first position in the optical axis direction; and
the O-ring is compressed in the optical axis direction at a position adjacent to the annular wall surface in the radial direction and exerts an urging force to urge the third lens toward the object side and to urge the second lens toward the first lens.

7. The lens unit according to claim 2, wherein a clearance is provided between the second lens and a plurality of the guide protrusions in a state in which the fitting portion and the fitted portion are fitted to each other.

8. The lens unit according to claim 7, wherein the lens barrel is made of a resin;
the first inner peripheral-surface portion is a tapered surface inclined to an outer peripheral side toward the object side; and
the first fitting protrusion includes a pressure-joining surface parallel to the optical axis at an end on an inner peripheral side.

9. The lens unit according to claim 8, wherein the second inner peripheral-surface portion is a tapered surface inclined to the outer peripheral side toward the object side; and
the guide protrusion includes a guide surface parallel to the optical axis at an end on an inner peripheral side.

10. The lens unit according to claim 9, further comprising:
a third lens disposed on the object side of the second lens; and
an O-ring disposed between the second lens and the third lens, wherein
the third lens and the O-ring are accommodated in the lens barrel;
the lens barrel includes an annular caulking portion which is bent to an inner peripheral side and is brought into contact with an outer peripheral-end portion of the third lens from the object side on an end part on the object side and a first stepped portion on an inner peripheral surface;
the first stepped portion includes an annular seating surface facing the object side at a position overlapping the caulking portion when viewed from the optical axis direction and an annular wall surface extending from an end on an inner peripheral side of the annular seating surface to the image side;
an outer peripheral-edge portion of the third lens is located between the caulking portion and the seating surface;
the first lens is supported from the image side at a predetermined first position in the optical axis direction; and
the O-ring is compressed in the optical axis direction at a position adjacent to the annular wall surface in the radial direction and exerts an urging force to urge the third lens toward the object side and to urge the second lens toward the first lens.
